(19) United States
(12) Patent Application Publication
(10) Pub. No.: US 2009/0266875 A1
(43) Pub. Date: Oct. 29, 2009

(54) METHOD FOR CHECKING THE AUTHENTICITY OF GOODS

(75) Inventors: Sens Ruediger, Ludwigshafen (DE); Thiel Erwin, Wilnsdorf (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaft, Ludwigshafen (DE)

(21) Appl. No.: 11/721,907

(22) PCT Filed: Dec. 14, 2005
(86) PCT No.: PCT/EP2005/013445

§ 371 Date: Jun. 15, 2007

(30) Foreign Application Priority Data
Dec. 15, 2004 (DE) 10 2004 060 315.4

(51) Int. Cl. G06F 17/00; G06K 7/10

(52) U.S. Cl. 235/375; 235/470

(57) ABSTRACT

A method checking the authenticity of goods, including marking and identification of the goods. A marking in a form of a patter having a pattern function is applied to the surface of the goods, a local change in physically measurable properties of the surface of the goods in the region of the marking being brought about by the marking; the marking is not perceptible by eye. The identification detects transmission, reflection or scattering of analytical radiation by the surface of the goods as a function of local coordinates and the wavelength of the analytical radiation, and thereby a response function is determined, which reproduces intensity of the transmitted, reflected or scattered analytical radiation as a function of the local coordinates and the wavelength, and by correlation analysis, the correlation of the response function with a known pattern function is determined. The marking is detected by the correlation.

The invention relates to a method for checking the authenticity of goods.

Brand piracy is the illegal use of symbols, names, logos (brands) and commercial designations which are used by the brand manufacturers to identify their products on the market. Product piracy is the forbidden copying and duplication of goods which have patent rights, design rights or copyrights for the legal manufacturer. Brand and product piracy takes over without permission the technical knowledge which a company has acquired over many years and through arduous work and the use of enormous financial means in order to use it for its products. It uses the knowledge of a brand, which has been obtained by a brand producer on the basis of its quality products, in order to confuse the consumer about the actual origin of the goods and quality.

Product piracy has become one of the most serious problems in industry and commerce. The increasing importance of know-how in the information community, modern production techniques and the worldwide exchange of goods make it easy nowadays to copy profitable products virtually identically and to introduce them into lucrative markets both at home and abroad. Inter alia, the products of the chemical industry, of the pharmaceutical industry, of the cosmetic industry, of the mineral oil industry, of the vehicle construction and supply industry, of the textile, shoe and clothing industry, of the toy industry, of the foodstuffs industry, of the electrical industry, digital media including software, film and music and the products of banks and state are affected.

A remedy can be provided by what are known as anti-counterfeiting technologies, which permit the authenticity of goods to be checked. These have to meet a series of requirements with regard to security against forgery, durability, resistance, cost-effectiveness, compatibility with distribution and consumer-friendliness.

Existing technologies for identifying and checking authenticity are firstly what are known as “open technologies”, that is to say technologies which operate with visible markings for checking authenticity, and secondly “hidden technologies”, that is to say those which operate with invisible markings. Examples of open technologies are the “optical variable ink” (OVI), that is to say a printing ink which changes its color as a function of the viewing angle, guilloche printing (line printing), intaglio printing (profile printing), holograms and watermarks. Examples of hidden technologies are fluorescent inks, “coin reactive ink” reacting to friction, thermoactive inks, biologically, chemically or spectroscopically detectable elements, what are known as “taggants”, microtext, raster text and digital watermarks. In addition, there exist machine-readable technologies such as chips which transmit data via radio waves, and magnetic systems.

It is an object of the invention to provide a method for checking the authenticity of goods. It is in particular an object of the invention to provide such a method which is secure against forgery, permanent, economical and consumer-friendly.

The object is achieved by a method for checking the authenticity of goods, comprising the marking and identification of the goods, in which
(i) in a marking step, a marking in the form of a pattern having a pattern function M(x, y) is applied to the surface of the goods, a local change in the physically measurable properties of the surface of the goods in the region of the marking being brought about by the marking, and this marking not being perceptible by eye,
(ii) in an identification step, the transmission, reflection or scattering of analytical radiation by the surface of the goods is detected as a function of the local coordinates (x, y) and the wavelength λ of the analytical radiation and in this way a response function A(x, y, λ) is determined, which reproduces the intensity of the transmitted, reflected or scattered analytical radiation as a function of the local coordinates (x, y) and the wavelength λ, and, by means of correlation analysis, the correlation of the response function A(x, y, λ) with the known pattern function M(x, y) is determined, it being possible for the marking to be detected by means of the correlation.

In a marking step (i), a marking in the form of a pattern is applied to the surface of the goods. The marking consists in a pattern-like change in the physically measurable surface properties of the goods, which is not perceptible by the eye. This can be done by the su ace of the goods to be marked being exposed to any desired external action which is suitable to change its physically measurable properties, the external action following a pattern. The external action will be designated an environmental influence in the following text. External actions (environmental influences) comprise the action of light or, in general, of radiation, of mechanical forces, of chemicals, of gases, of microorganisms, of radioactive radiation, of sound (for example ultrasound) or of heat on the surface. The environmental influence can be exerted, for example, by means of irradiation or by means of the application of chemicals to the surface of the goods, “chemicals” meaning all substances or mixtures of substances which are able to react with the surface or with the substances contained in the latter.

The properties of the surface are physically measurable in the sense of the present invention if they can be registered by the interaction with an analytical radiation radiated onto the surface. Analytical radiation can be any desired radiation which is able to interact with the surface and can be transmitted, reflected or scattered by the latter. Examples are electromagnetic radiation, particulate radiation (neutrons, radioactive alpha radiation) or acoustic radiation (for example ultrasound).

It is important that the environmental influence which is suitable to change the physically measurable properties of the surface acts on the surface with a specific, known, location-dependent intensity distribution I(x, y). In other words: the action of the environmental influence on the surface is not homogeneous but has an intensity pattern. This intensity pattern can be a simple geometric pattern, for example a strip pattern or a checkerboard pattern. The intensity pattern can, however, also be completely irregular. For example, the intensity pattern can correspond to a trademark.

If the environmental influence acting on the surface is light with a specific wavelength or with a specific spectral distribution, then the intensity can be equated with the radiation intensity, which is measured in W/cm². If the acting environmental influence is the action of mechanical forces which, for example, are caused by a substrate surface being subjected to a sandblast, then the intensity of this environmental influence can be equated with the number of sand particles striking the substrate surface per unit time and unit area. If the acting environmental influence is the action of chemicals or gases, then the intensity of this environmental influence can be equated with the concentration of a specific substance at the location of the substrate surface.

The pattern is preferably produced by allowing the environmental influence to act on the surface through one or more masks which have a specific location-dependent transmission function T(x, y) (transmission pattern), and in this way a location-dependent intensity distribution I(x, y) of the environmental influence corresponding the location-dependent transmission function is obtained, which produces the pattern as an image of the mask on the surface of the goods. In this case, the pattern function M(x, y) on which the pattern is based corresponds to the transmission function T(x, y) of the mask.

The transmission function T(x, y) describes the location-dependent transparency of the mask for the environmental influence. If the acting environmental influence is light, then the mask can, for example, consist of a film which is substantially transparent to the light and which contains a pattern printed on, the printed regions having a lower transmission for light of a specific wavelength or of a specific wavelength range or being substantially non-transparent. This film can be placed onto the surface in order to produce the corresponding intensity pattern on the surface during the irradiation. If the acting environmental influence is the mechanical action on the surface effected by a sandblast, then the mask can be a stencil which has cutouts through which the sandblast can act on the surface, but which otherwise covers the surface and protects it against the action of the sandblast. If the acting environmental influence is the action of chemicals, of gases or microorganisms, then the mask can likewise be a stencil having cutouts. In the case of chemicals or microorganisms, the formulations containing these can be painted onto the stencil. The regions of the surface covered by the stencil are then protected against the action of the formulations, while the surface comes into contact with the formulation in the cutouts of the stencil.

However, it is also possible to apply an intensity pattern to the surface without using a mask. For instance, in the case of light acting on a sample, the intensity distribution I(x, y) can be produced as a diffraction pattern on the surface.

In a preferred embodiment of the method according to the invention, the marking is printed onto the surface of the goods by conventional printing processes such as letterpress printing, gravure printing, offset printing and inkjet printing. In this case, printing inks with a minimum colorant content are used, which result in markings which are not perceptible by eye. Preference is given to pigmented printing inks with high lightfastness. Suitable pigments are, for example, organic and inorganic pigments such as monazo pigments, diazo pigments, anthanthrone pigments, anthraquinone pigments, anthrapyrimidine pigments, quinacridone pigments, quinophthalone pigments, dioxazine pigments, flavanthrone pigments, indanthrone pigments, isoindoline pigments, isoindolinone pigments, isoviolanthrone pigments, metal complex pigments, perinone pigments, perylene pigments, phthalocyanin pigments, pyranthrone pigments, thioindigo pigments, triarylcarbonium pigments and inorganic white, black and colored pigments. Printing inks with soluble, lightfast colorants can also be used. Examples of these are soluble derivatives of the phthalocyanin chromophore, preferably with metals such as copper, zinc or aluminum as central atom.

In a further preferred embodiment of the method according to the invention, the marking is produced photochemically. For this purpose, the surface is preferably irradiated with high-energy light, local changes in the physically measurable properties being induced photochemically in the surface. The irradiation is preferably carried out through a mask which contains the pattern, that is to say through a mask having a transmission function corresponding to the pattern function.

In an identification step (ii), the transmission, reflection or scattering of analytical radiation by the surface of the goods is detected as a function of the local coordinates (x, y) and, if appropriate, as a function of the wavelength λ of the analytical radiation.

The analytical radiation can have a discrete wavelength, for example the wavelength of the CO band at 5.8 μm (corresponding to 1720 cm⁻¹) or else comprise a wavelength range, for example the entire visible spectral range from 400 to 800 nm. The transmission, reflection or scattering of the analytical radiation by the surface generally depends on the wavelength of the analytical radiation. A response function A(x, y, λ) is therefore obtained which reproduces the intensity of the transmitted, reflected or scattered analytical light as a function of the local coordinates (x, y) and the wavelength λ. This response function can be determined for discrete wavelengths λ or for one more wavelength ranges Δλ (for example for the red, green and blue region of the visible light).

The wavelength of the analytical radiation or its spectral composition depends on the type of marking. In general, it will be analytical light in the UV-VIS and/or NIR region of the spectrum. For example, in the case of a marking with colorants, it will be analytical light in the UV-VIS region. If the marking consists in a pattern-like, light-induced aging of a plastic, which manifests itself in the intensity of the CO band at 5.8 μm, the analytical radiation will comprise this wavelength.

In one embodiment of the method according the invention, the reflection of the analytical light by the surface is determined. In this case, telecentric measuring optics are preferably used. In a further embodiment of the method according to the invention, the scattering of the analytical light by the surface is detected. In this case, a confocal color measuring system is preferably used.

The reflection or scattering of the analytical radiation by the substrate surface as a function of the local coordinates (x, y) and of the wavelength λ can also be detected with a color scanner or a digital camera.

The detection of radioactive or acoustic radiation (ultrasound) can be carried out with imaging methods known from medical diagnostics. Thermal infrared radiation can be detected with a thermal imaging camera.

The response function A(x, y, λ) is generally determined from the detected intensity values with a digital image evaluation system.

A response function is obtained which reproduces the intensity of the transmitted, reflected or scattered analytical radiation as a function of the local coordinates (x, y) and, if appropriate, the wavelength λ.

In a further step, by means of correlation analysis, the correlation of the response function A(x, y, λ) with the known pattern function M(x, y) is determined, it been possible for the marking to be detected by means of the correlation and in this way authenticity checking of the goods being carried out.

Correlation analysis is a mathematical method known per se for the detection of characteristic patterns. Correlation analysis methods have been described extensively in the literature. The extent to which the (measured) response function is correlated with a comparison function is examined.

For this purpose, a generalized correlation function is calculated:

$$K ( α , β , {x}_{0} , {y}_{0} , λ ) = {\int }_{- ∞}^{∞} {\int }_{- ∞}^{∞} V ( α x + {x}_{0} , β y + {y}_{0} , λ ) \cdot A ( x , y , λ ) d x d y$$

α, β are freely selectable scaling parameters, x₀, y₀ are freely selectable position parameters. The above equation is to be understood to mean that the integration is carried out over two coordinates or possibly only over one coordinate. The values for V and A for variables which exceed the measurement range are set equal to 0.

The correlation function provides information about the extent to which the response function A(x, y, λ) is correlated with a comparative function V(αx+x₀, βy+y0, λ) and how greatly this correlation changes when its variables are changed, that is to say how significant the correlation is.

The comparative function can be but does not have to be identical with the intensity distribution I(x, y, λᵤ) of the environmental influence or the basic pattern function M(x, y, λᵤ) or else the product of intensity distribution I(x, y, λᵤ) and pattern function M(x, y, λᵤ). The comparative function describes in general terms the change in the property of the surface to be expected or looked for as a result of the marking. However, this change in property is expected to exhibit the characteristic pattern of the marking or of the intensity distribution of the environmental influence.

For instance, if the marking consists in a change in the reflection of the surface carried out by means of irradiation with light, the comparative function should be selected such that its x-y dependence corresponds to the known x-y dependence of the known locally dependent intensity distribution I(x, y, λᵤ) or the basic pattern function M(x, y, λᵤ) or the product of intensity distribution I(x, y, λᵤ) and pattern function M(x, y, λᵤ). The comparative function does not have to have any explicit wavelength dependence.

The correlation function images only the desired change in the surface, that is to say that caused by the marking, and effectively suppresses interfering influences such as statistical noise, sample inhomogeneities and influences of external light. This results in a very high sensitivity.

One variant of the general correlation analysis is Fourier analysis.

In one embodiment of the method according to the invention, the marking has a periodic pattern with a local frequency α. This marking can be produced by printing the surface by means of a conventional printing process. However, it can also be produced by exposure or general irradiation of the surface, the exposure or irradiation being carried out with a corresponding periodic intensity distribution I(x, y, λ) with a local frequency α. A periodic intensity distribution can be produced by a mask having a periodic transmission function T(x, y, λ)=M(x, y, λ) being used. This can be, for example, what is known as a bar code mask, for example a transparent film having an imprint of regularly (equidistantly) arranged, (largely) non-transparent bars (what is known as a black/white bar code mask), or a stencil having an appropriate sequence of rectangular cutouts. Instead of using a mask, an optical grating having an appropriate pattern function M(x, y, λ) can also be projected onto the surface.

As an example, in the following text a correlation analysis method for determining the correlation between the location-dependent intensity distribution I(x, y, λ) or the corresponding pattern function M(x, y λ) of the marking and the response function A(x, y, λ) will be described. Correlation analysis methods are known per se and have been described extensively in the literature. The invention therefore does not consist in providing such mathematical methods either.

If the transmission function of the mask, which produces a specific intensity distribution, or the pattern function has a periodic structure, then the result is particularly clear relationships. For instance, if the transmission function

T(x, y, λu)=½(1+cos(α₀x))

is chosen, and if the pattern on the surface of the goods in produced photochemically, since V(x, y, λ)=I(x, y, λ)=T(x, y, λ), it is true that

$$K ( α , β , {x}_{0} , {y}_{0} , λ ) = {\int }_{- ∞}^{∞} \frac{1}{2} \cdot ( 1 + cos ( α x ) ) \cdot A ( x , y ) d x$$

Therefore, the correlation function is the real Fourier transformation of the response function, apart from a constant. α thus be understood as a local frequency. Furthermore, only at the inherent frequency α₀ of the mask does K(α, β, x₀, y₀, λ) exhibit a term which is brought about by the irradiation. At all the other local frequencies α≠α₀ the correlation function vanishes. Thus, an infinitely high local frequency resolving power α₀/Δα is obtained.

In practice, however, it is necessary to take account of the fact that, because of the finite sample size xₘₐₓ, the integration cannot be carried out from minus infinity to plus infinity. Furthermore, measurements are not made continuously; instead the response function is digitalized with a limited number of reference points. The density of the reference points results in an upper limit for the local frequency which can still be measured. By contrast, the finite sample size results in a finite local frequency resolving power α₀/Δα which is given by α₀/Δα=α₀·xₘₐₓ.

This means that interference caused by statistical processes (signal noise) is suppressed less effectively than in the case of an infinitely high local frequency resolving power. In practice, however, it has been shown that, despite these restrictions, the method according to the invention has a sensitivity higher by more than one hundred times as compared with visual inspection.

The pattern recognition by means of correlation analysis results in a very high sensitivity of the detection of the marking on the surface of the goods. It is thus possible to detect with high sensitivity markings which cannot be perceived visually, and in this way to permit authenticity checking of the goods.

The surfaces to be marked can consist of any desired materials, for example the surfaces of metals, plastics, wood, paint, paper or board. The marking can be applied to the goods themselves, if these are suitable for the application of markings, or to their packaging. The term “goods” in the sense of the invention therefore also comprises the packaging of the goods. The goods to be marked can originate from any desired sectors. Examples are the products of the chemical and pharmaceutical industry, the mineral oil industry, the vehicle construction and supply industry, the textile and clothing industry, the toy industry, the foodstuffs, beverage and the semi-luxury consumer products industry, the electrical industry, the cosmetic and body care industry, the products of machinery and plant construction, software, digital media and entertainment electronics.

The invention will be explained in more detail by the following examples.

### EXAMPLES

### Example 1

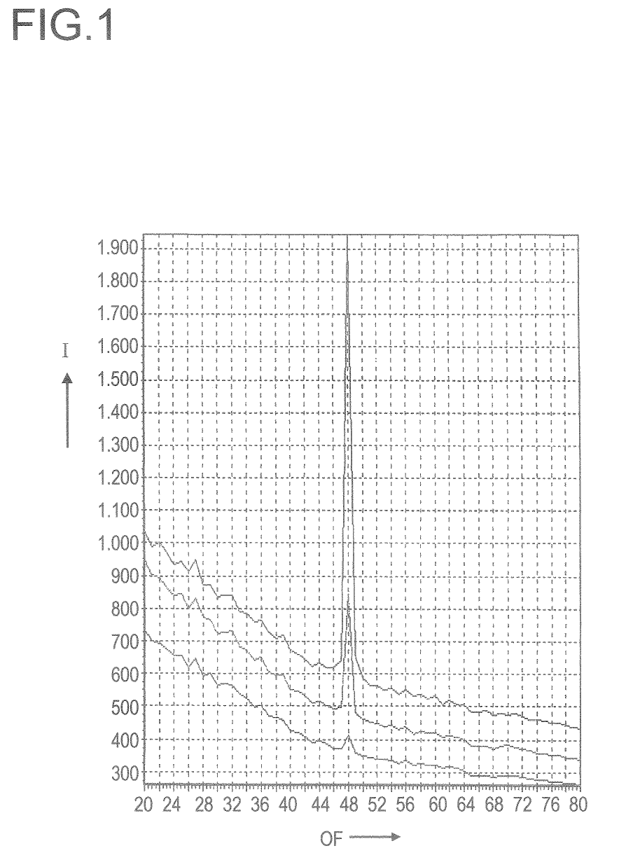

With the aid of an exposure apparatus, an invisible item of bar code information was written into the wooden board made of pine, illustrated in FIG. 1, as follows. For this purpose, a bar code pattern with a period length of 1 mm was produced on a film of the AGFA film type (type 3ZESP) with the aid of the exposure of the type Pantherpro/46 from the Prepress company. The film, having the dimensions 8×8 cm, was fixed the pine board by thumb tacks at all 4 corners, the grid of the film being oriented at right angles to the grain of the wood (see FIG. 1). Care was taken that the film lay as flat as possible on the smooth wooden surface and that the film could not move during the irradiation. The wooden board prepared in this way was exposed to sunlight for 30 minutes, the sunlight falling approximately vertically onto the sample surface.

Following the exposure, the film grid was taken off and the surface of the wood assessed visually. No visually perceptible change in the sample surface could be detected by eye (no grid could be detected).

Following the irradiation, the grid film was removed. Grid film and wooden panel (exposed side downward) were placed onto the object platen of a scanner of the HP SCANJET 550 C type and scanned in under the following conditions:

True Color (16.7 million colors)

### Resolution: 1200 dpi

Contrast: medium
Color: automatic
Exposure: automatic

The R G B signals from the irradiated surface of the wood were then subjected to a one-dimensional Fourier transformation. Let the intensities measured by the scanner be designated Sⱼ(k, m). In this case, the index j designates the R G B colors (red, green and blue). By contrast, the variables k and m indicate the location at which the intensity was measured. The direction indicated by k or m will be designated the image line or image column in the following text. With the aid of the mathematical operation:

$${P}_{j} ( {k}^{′} , m ) = \sqrt{\begin{matrix}{[ {\int }_{all ck} {S}_{j} ( k , m ) \cdot sin ( 2 \cdot π \cdot {k}^{′} \cdot k ) d k ]}^{2} + \\ {[ {\int }_{allck} {S}_{j} ( k , m ) \cdot cos ( 2 \cdot π \cdot {k}^{′} \cdot k ) \cdot d k ]}^{2}\end{matrix}}$$

the power spectrum Pⱼ(k′, m) was calculated for each image line. The power spectra obtained in this way for each image line were averaged over all the image columns:

$$\overline{{P}_{j} ( {k}^{′} )} = \frac{{\sum }_{all image lines} {P}_{j} ( {k}^{′} , m )}{No . of image lines}$$

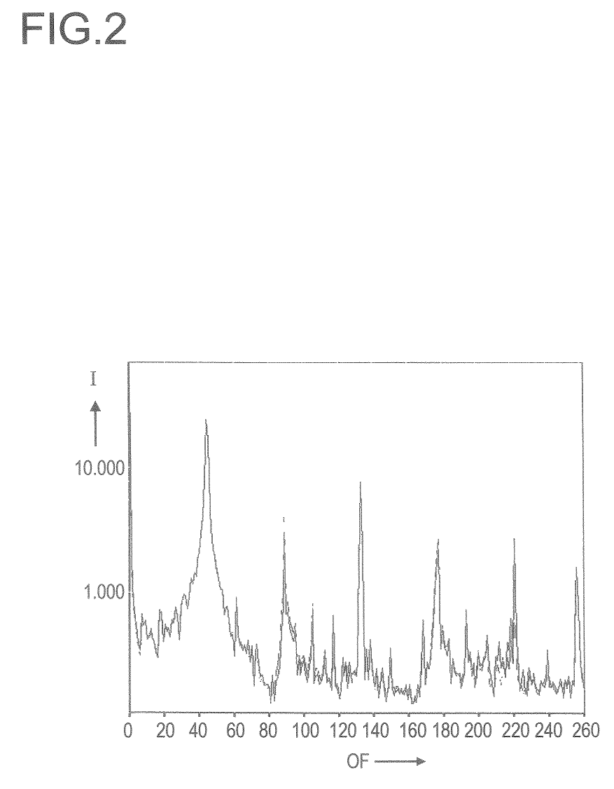

In the examples shown, in each case the averaged power spectrum P̅ⱼ̅(̅k̅′̅)̅ is plotted against the local frequency k′. Photochemical signals can be detected clearly in the R, G, B channels as a result of the fact that, at the local frequency determined by the film grid, a considerably increased intensity of the average power spectrum is established. The height of this intensity in the individual channels is a measure of the visually non-perceptible bar code information. The variables plotted on the X axis and the Y axis in FIGS. 1 and 2 are proportional to the local frequency and the intensity of the averaged power spectrum.

The result of the one-dimensional Fourier transformation is illustrated in FIG. 1.

The FT power spectrum of the grid film is illustrated in FIG. 2.

From FIG. 2, the dimensionless local frequency of 44 of the grid can be detected. At this local frequency, in FIG. 2 a very high signal peak is observed in the blue channel, a medium signal peak in the green channel and a relatively small signal peak in the blue channel. This corresponds to a bar code in a brown color far below the visibility limit. The peak heights of the signals are plotted logarithmically in order to make small effects such as noise, etc., better visible. The photochemically produced information could still be read with the aid of the evaluation method described above after uniform exposure to daylight for a month.

### Example 2

Example 1 was repeated but irradiation was carried out with an artificial exposure apparatus for 5 sec. with a radiation intensity of 3 times the intensity of sunlight. Similar results were obtained to those obtained in example 1.

### Example 3

With the aid of an inkjet printer of the HP 2000 C type, by using the PowerPoint program, a visually non-perceptible pattern was printed on a blue background (EPSON special paper with the dimensions 9×11 cm) with the following settings:

| | | | |
|---|---|---|---|
| Red: | 53 | Hue: | 170 |
| Blue: | 53 | Saturation: | 153 |
| Green: | 205 | Intensity: | 129 |

The period of the grid was 1/cm. The grid information was printed at right angles to the print lines of the inkjet printer.

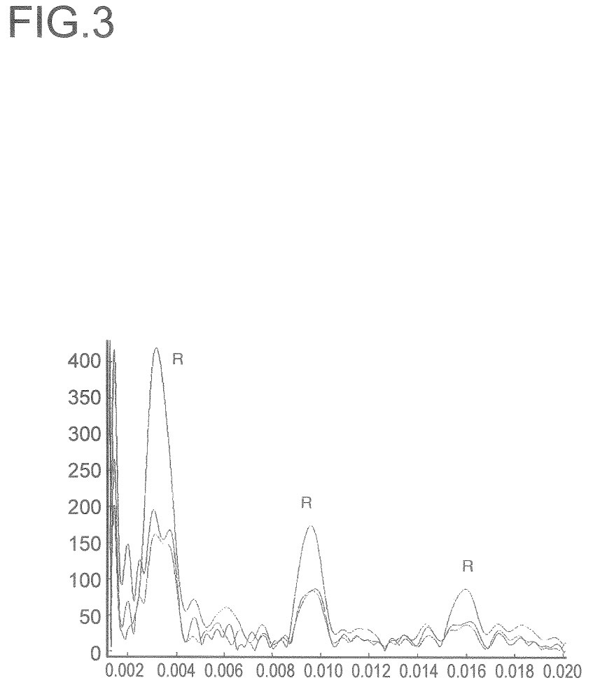

The print produced in this way was scanned in as described in example 1. With the aid of the evaluation method described in example 1, the result illustrated in FIG. 3 was obtained.

FIG. 3 reveals the basic frequency and 2 harmonic overtones of the invisible bar code pattern. The effects are particularly clearly pronounced in the absorption range oil the blue print, that is to say in the red channel. The amplitudes (in arbitrary units) of the basic frequency and of the two overtones in the red channel are: 420:170-80.

1-13. (canceled)

14. A method for checking the authenticity of goods, comprising:
(i) a marking, in which a marking in a form of a pattern having a pattern function is applied to a surface of the goods, a local change in physically measurable properties of the surface of the goods in the region of the marking being brought about by the marking, and the marking not being perceptible by eye, whereby the marking on the surface of the goods is produced such that having a specific, location-dependent intensity distribution that corresponds to the pattern function is permitted to act on the surface;
(ii) an identification in which transmission, reflection, or scattering of analytical radiation by the surface of the goods is detected as a function of local coordinates and wavelength of the analytical radiation, and in this way a response function is determined, which reproduces intensity of the transmitted, reflected, or scattered analytical radiation as a function of the local coordinates and the wavelength, and, by correlation analysis, correlation of the response function with a known pattern function is determined, the marking being detected by the correlation.

15. The method as claimed in claim 14, wherein the marking is produced photochemically.

16. The method as claimed in claim 14, wherein the intensity distribution is produced by environmental influence being allowed to act on the surface through a mask that has a transmission function corresponding to the intensity distribution.

17. The method as claimed in claim 14, wherein the pattern is an irregular pattern.

18. The method as claimed in claim 14, wherein the pattern is a regular pattern having a local frequency.

19. The method as claimed in claim 18, wherein the correlation analysis is a Fourier analysis.

20. The method as claimed in claim 14, wherein the reflection of the analytical light is detected.

21. The method as claimed in claim 20, wherein telecentric measuring optics are used in the detection.

22. The method as claimed in claim 14, wherein the scattering of the analytical light is detected.

23. The method as claimed in claim 22, wherein a confocal color measuring system is used in the detection.

24. The method as claimed in claim 14, wherein the response function is determined with digital image evaluation electronics.

25. The method for marking goods comprising the marking (i) as claimed in claim 14.

26. The method for the identification of goods comprising the identification (ii) as claimed in claim 14.
